(19) United States
(12) Patent Application Publication
(10) Pub. No.: US 2025/0135947 A1
(43) Pub. Date: May 1, 2025

(54) Method for Controlling an On-Board Power Supply System for a Motor Vehicle, On-Board Power Supply System and Motor Vehicle

(71) Applicant: Bayerische Motoren Werke Aktiengesellschaft, Muenchen (DE)

(72) Inventors: Xavier ANZUELA RECASENS, Muenchen (DE); Marcel FENKART, Starnberg (DE); Joachim FROESCHL, Herrsching (DE); Maximilian HASE, Muenchen (DE); Andre SCHMITZ, Muenchen (DE)

(21) Appl. No.: 18/714,560

(22) PCT Filed: Nov. 10, 2022
(86) PCT No.: PCT/EP2022/081477

§ 371 Date: May 29, 2024

(30) Foreign Application Priority Data
Dec. 1, 2021 (DE) 10 2021 131 608.1

(51) Int. Cl. B60L 58/14; B60L 50/60; B60L 58/16; B60L 58/20

(52) U.S. Cl. CPC B60L 58/14; B60L 50/60; B60L 58/16; B60L 58/20; B60L 2210/10; B60L 2240/545

(57) ABSTRACT

An on-board power supply system for a motor vehicle that includes a high-voltage voltage network with a high-voltage energy storage device for supplying voltage to one or more high-voltage consumers, a main converter for converting the high-voltage voltage present in the high-voltage voltage network into a predetermined low-voltage voltage present in the low-voltage voltage system for supplying voltage to one or more low-voltage consumers, a battery management system, and a bypass converter assembly. The bypass converter assembly is configured to transfer a specific, maximum permissible amount of energy from the high-voltage voltage network to the low-voltage voltage network during a parking phase of the motor vehicle.

### CROSS REFERENCE TO RELATED APPLICATION

This application is a 371 of International Application No. PCT/EP2022/081477, filed Nov. 10, 2022 which claims priority under 35 U.S.C. § 119 from German Patent Application No. 10 2021 131 608.1, filed Dec. 1, 2021, the entire disclosure of which is herein expressly incorporated by reference.

### BACKGROUND AND SUMMARY

The invention relates to an on-board power supply system for a motor vehicle, which comprises a high-voltage energy store for supplying a high-tension voltage network for the supply of voltage to one or more high-voltage loads, a main converter for converting the high-tension voltage which is present in the high-tension voltage network into a predefined low-tension voltage in a low-tension voltage network for the supply of voltage to one or more low-voltage loads, and a battery management system. The invention further relates to a method for controlling an on-board power supply system of this type, and to a motor vehicle having this type of on-board power supply system.

On-board power supply systems of this type are known, and are customarily an element of electric or hybrid vehicles having a traction store which forms the high-voltage energy store (high-tension voltage energy store), and an on-board power supply system which forms the low-tension voltage network and which supplies a low-tension voltage, for example 12 V, or which operates at a low-tension voltage or low voltage. As a voltage source for the low-tension voltage network, a low-voltage on-board power supply battery is customarily provided.

The fundamental problem is that energy consumption in a parked vehicle results in the discharging of the low-voltage on-board power supply system battery. In consequence, this battery must be dimensioned with a sufficiently high rating to ensure a reliable voltage supply over a given time period.

It is further known, during the parking phase or immobilization time of a motor vehicle, for the high-voltage energy store to be employed as a voltage source for the low-tension voltage network. However, this entails a risk that the high-voltage energy store will achieve an unacceptable state of deep discharge, with a resulting impairment of its performance capability.

The object of the invention is the provision of an on-board power supply system which ensures a reliable voltage supply over a particularly prolonged period during the parking phase of a motor vehicle. A further object of the invention is the provision of a method for operating an on-board power supply system of this type.

This object is fulfilled by a method for controlling an on-board power supply system for a motor vehicle, which comprises a high-voltage energy store for supplying a high-tension voltage network for the supply of voltage to one or more high-voltage loads, a main converter for converting the high-tension voltage which is present in the high-tension voltage network into a predefined low-tension voltage in a low-tension voltage network for the supply of voltage to one or more low-voltage loads, a battery management system and a bypass converter assembly. The bypass converter assembly is designed, during a parking phase of the motor vehicle, to introduce a predefined quantity of energy from the high-tension voltage network into the low-tension voltage network. The method comprises the following steps:

Totalization of the quantity of energy which, during a parking phase of the motor vehicle, is introduced via the bypass converter assembly into the low-tension voltage system; and
a) Switch-off of the bypass converter assembly, if the totalized quantity of energy exceeds a specific and maximum permissible quantity of energy, the drawing of which from the high-voltage energy store is permitted during a parking phase of the motor vehicle.
b) Within the meaning of the invention, in particular, the parking phase of the motor vehicle is a phase during which the motor vehicle is not actively operated, and is parked or immobilized. This state can further be defined by the deactivation of the ignition of the motor vehicle, by the run-out of a timer associated with the deactivation of ignition, and/or by detection to the effect that the driver or passengers of the vehicle has/have left (and optionally locked) the motor vehicle.

The arrangement of a bypass converter assembly separately from the main converter provides an advantage, in that the former can be specifically calibrated to introduce electrical energy from the high-tension voltage network into the low-tension voltage network during a parking phase, in which power demand is significantly lower than during the active operation of the motor vehicle, or during travel. If the bypass converter assembly, for example, assumes optimum efficiency at a lower power than the main converter, the supply of voltage to the low-tension voltage network can be ensured with a far superior efficiency, and thus over a longer duration, than that associated with the supply of voltage to the low-tension voltage network from the main converter during the parking phase. Moreover, the switch-off of the bypass converter assembly in the event of an overshoot of the maximum permissible quantity of energy ensures that the high-voltage energy store is not discharged below a stipulated threshold, i.e. a stipulated threshold value, as a result of which the high-voltage energy store is protected against any unacceptable deep discharge during a parking phase.

The maximum permissible quantity of energy can be determined by the battery management system and communicated to the bypass converter assembly prior to the switch-off of the battery management system during the parking phase of the motor vehicle. In this manner, the maximum permissible quantity of energy can be reliably determined, and energy consumption during the parking phase reduced by the switch-off of the battery management system.

In one embodiment, the maximum permissible quantity of energy is determined by the battery management system by reference to the weakest cell of the high-voltage energy store, in order to reliably preclude any unacceptable deep discharge of the high-voltage energy store.

Additionally or alternatively, for the determination of the maximum permissible quantity of energy, the temperature of the high-voltage energy store and/or the state-of-health of cells in the high-voltage energy store can be considered. Accordingly, a particularly high value can be selected for the maximum permissible quantity of energy, while simultaneously minimizing the risk that drawing the maximum permissible quantity of energy from the high-voltage energy store will impair the performance capability thereof.

According to the invention, for the fulfilment of the above-mentioned object, an on-board power supply system for a motor vehicle, having a high-tension voltage network comprising a high-voltage energy store for the supply of voltage to one or more high-voltage loads, a main converter for converting the high-tension voltage which is present in the high-tension voltage network into a predefined low-tension voltage in a low-tension voltage network for the supply of voltage to one or more low-voltage loads, a battery management system and a bypass converter assembly are also provided. The bypass converter assembly is designed, during a parking phase of the motor vehicle, to introduce a predefined and maximum permissible quantity of energy from the high-tension voltage network into the low-tension voltage network. The on-board power supply system thus assumes the above-mentioned advantages. In particular, the on-board power supply system, as a result of the bypass converter assembly, is particularly energy-efficient, and thus ensures a reliable supply of voltage to the low-tension voltage network over a particularly prolonged period during the parking phase. The high-voltage energy store is further protected against any unacceptable deep discharge, as the quantity of energy which can be introduced from the high-tension voltage network into the low-tension voltage network during a parking phase of the motor vehicle is limited to a stipulated value.

In one embodiment, the main converter is configured as a DC/DC converter having a maximum capacity of at least 1 kW, in order to prevent any significant impairment of the power of the motor vehicle during operation.

Additionally or alternatively, the bypass converter assembly can be configured as a DC/DC converter having a maximum capacity not exceeding 100 W, in particular not exceeding 50 W. In this manner, the bypass converter assembly can be configured with a particularly energy-efficient design, in order to permit the electrical operation of the low-tension voltage network by means of the maximum permissible quantity of energy over a particularly prolonged period during the parking phase.

According to a further embodiment, the bypass converter assembly is structurally integrated in the high-voltage energy store or in a common housing, and is protected accordingly.

According to the invention, for the fulfilment of the above-mentioned object, a motor vehicle having an on-board power supply system according to the invention, and having the above-mentioned advantages, is also provided.

It can be provided that the motor vehicle comprises an electric drive machine for electric driving operation, wherein the high-voltage energy store is designed to supply energy to the electric drive machine.

Further advantages and features proceed from the following description and from the attached drawings. In the drawings:

### BRIEF DESCRIPTION OF THE DRAWINGS

FIG. 1 shows a schematic representation of a motor vehicle having an on-board power supply system according to the invention; and

FIG. 2 shows a schematic representation of the on-board power supply system according to FIG. 1.

### DETAILED DESCRIPTION OF THE DRAWINGS

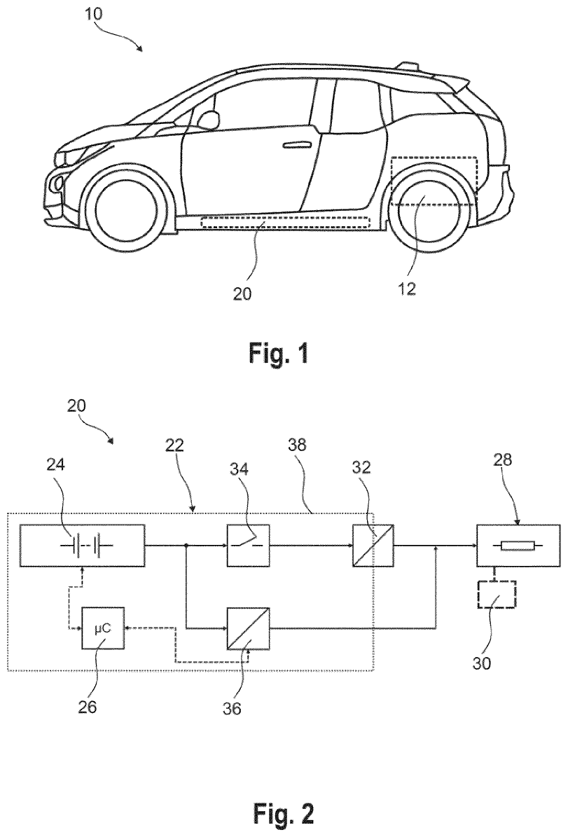

FIG. 1 shows a motor vehicle 10 having an on-board power supply system 20.

The motor vehicle 10 comprises an electric drive machine 12 in the form of an electric motor, by means of which the motor vehicle 10 can be propelled for driving operation.

For example, the motor vehicle 10 is an electric vehicle or a hybrid vehicle.

The on-board power supply system 20 (see FIG. 2), comprises a high-tension voltage network 22 having a high-voltage energy store 24 and a battery management system 26 which is assigned to the high-voltage energy store 24, together with a low-tension voltage network 28.

The high-voltage energy store 24 forms a traction store of the motor vehicle 10, i.e. a store for electrical energy which is required for the propulsion of the motor vehicle 10.

The low-tension voltage network 28 can optionally comprise a low-voltage energy store 30, for example in the form of a low-voltage on-board power supply system battery.

The high-tension voltage network 22 is designed for the voltage supply of one or more high-voltage loads with a high-tension voltage, in particular with a high-tension voltage in excess of 220 V, for example 400 V or 800 V.

In the present exemplary embodiment, the high-tension voltage network 22 is designed for the voltage supply of the electric drive machine 12.

The low-tension voltage network 28 is designed for the voltage supply of one or more low-voltage loads with a low-tension voltage, in particular with a low-tension voltage of less than 150 V, for example 48 V, 24 V or 12 V.

The high-tension voltage system 22 further comprises a main converter 32 which, by means of a disconnector 34, can be electrically coupled to the high-voltage energy store 24 or electrically isolated therefrom.

The main converter 32 is designed to convert the high-tension voltage of the high-tension voltage network 22 into the low-tension voltage of the low-tension voltage network 28, in order to supply low-voltage loads on the low-tension voltage network 28 with the low-tension voltage.

In this connection, the main converter 32 is a DC/DC converter having a maximum capacity of 3-5 kW.

In principle, the main converter 32 can be a DC/DC converter having a maximum capacity of at least 1 kW.

The main converter 32 further assumes an optimum efficiency at 1 kW.

Additionally to the main converter 32, the high-tension voltage network 22 comprises a bypass converter assembly 36, which is electrically connected to the high-voltage energy store 24 and which is designed, independently of the main converter 32, to convert the high-tension voltage of the high-tension voltage network 22 into the low-tension voltage of the low-tension voltage network 28, in order to supply low-voltage loads on the low-tension voltage network 28 with the low-tension voltage.

In the present exemplary embodiment, the main converter 32 and the bypass converter assembly 36 are connected in parallel.

The bypass converter assembly 36 is configured as a DC/DC converter having a maximum capacity of 100 W.

In an alternative embodiment, the bypass converter assembly 36 is configured as a DC/DC converter having a maximum capacity of 50 W.

The bypass converter assembly 36 further assumes an optimum efficiency at 1-2 W.

In the present exemplary embodiment, the bypass converter assembly 36 and the high-voltage energy store 24, together with the battery management system 26 and the main converter 32, are accommodated in a housing 38.

In an alternative embodiment, the bypass converter assembly 36 is integrated in the housing 38 or in the high-voltage energy store 24.

Moreover, the high-voltage energy store 24 and the bypass converter assembly 36 are connected to the battery management system 26 in a signal-transmitting arrangement.

In order to supply specific low-voltage loads with a low-tension voltage while the motor vehicle 10 is parked and is not in active operation, i.e. the motor vehicle 10 is in a parking phase, the low-tension voltage network 28 is supplied with a low-tension voltage by means of the bypass converter assembly 36, as described hereinafter.

In the event of the detection of a parking phase by the battery management system 26, the battery management system 26 determines a maximum permissible quantity of energy which can be drawn from the high-voltage energy store 24, for the introduction thereof into the low-tension voltage network 28 during the parking phase.

The battery management system 26 determines the maximum permissible quantity of energy by reference to the weakest cell in the high-voltage energy store 24, for example wherein the number of cells in the high-voltage energy store 24 is multiplied by the maximum quantity of energy which it is permissible to draw from the weakest cell in the high-voltage energy store 24 without causing the transition thereof to a critical state, i.e. a state of deep discharge of the cell or of the high-voltage energy store 24, or a state in which the performance capability of the high-voltage energy store 24 would be permanently impaired.

For the determination of the maximum permissible quantity of energy, the battery management system 26 further considers the ambient temperature, the temperature of the high-voltage energy store 24 and/or the state-of-health of cells in the high-voltage energy store 24, for example wherein the available quantity of energy is multiplied by a corresponding factor, which has been saved in a memory of the battery management system 26 for this purpose.

In a subsequent step, the battery management system 26 communicates the maximum permissible quantity of energy thus determined to the bypass converter assembly 36.

Thereafter, the battery management system 26 is switched off, in order to reduce energy consumption during the parking phase.

In a further step, the disconnector 34 is opened, and the main converter 32 is thus electrically isolated from the high-voltage energy store 24. With effect from this time point, the voltage supply of the low-tension voltage network 28 by the high-voltage energy store 24 is thus executed via the bypass converter assembly 36.

In this connection, the bypass converter assembly 36 is designed to totalize the quantity of energy which is introduced into the low-tension voltage network 28 via the bypass converter assembly 36 during the parking phase, and to execute a switch-off immediately the maximum permissible quantity of energy is exceeded, in order to interrupt any further take-up of energy from the high-voltage energy store 24.

In this manner, during the parking phase of the vehicle 10, the low-tension voltage network 28 can be supplied with voltage by means of the high-voltage energy store 24, without endangering the high-voltage energy store 24.

As the optimum efficiency of the bypass converter assembly 36 is calibrated in accordance with power demand during the parking phase, the low-tension voltage network 28 is supplied with voltage by means of the bypass converter assembly 36 in a particularly energy-efficient manner.

The bypass converter assembly 36 further functions independently of the battery management system 26, such that the battery management system 26 can be switched off during the parking phase.

This provides an advantage, in that a particularly prolonged supply of energy during the parking phase can be ensured, particularly over a duration of at least 6 weeks.

Moreover, the low-voltage energy store 30 can thus be configured with a particularly low rating, or can be entirely omitted.

The invention is not limited to the embodiment illustrated. In particular, individual features of one embodiment can be arbitrarily combined with features of other embodiments, particularly in a manner which is independent of other features of the corresponding embodiments.

1-10. (canceled)

11. A method for controlling an on-board power supply system for a motor vehicle, wherein the motor vehicle comprises a high-voltage energy store for supplying a high-tension voltage network for the supply of voltage to one or more high-voltage loads, a main converter for converting the high-tension voltage which is present in the high-tension voltage network into a predefined low-tension voltage in a low-tension voltage network for the supply of voltage to one or more low-voltage loads, a battery management system, and a bypass converter assembly that during a parking phase of the motor vehicle introduces a predefined quantity of energy from the high-tension voltage network into the low-tension voltage network, the method comprising the following steps:
a) introduce, during a parking phase of the motor vehicle and via the bypass converter assembly into the low-tension voltage system, a totalization of the quantity of energy; and
b) switch-off of the bypass converter assembly, if the totalized quantity of energy exceeds a specific and maximum permissible quantity of energy, the drawing of which from the high-voltage energy store is permitted during a parking phase of the motor vehicle.

12. The method of claim 11, wherein the maximum permissible quantity of energy is determined by the battery management system and is communicated to the bypass converter assembly prior to the switch-off of the battery management system during the parking phase of the motor vehicle.

13. The method of claim 12, wherein the maximum permissible quantity of energy is determined by the battery management system by reference to the weakest cell of the high-voltage energy store.

14. The method of claim 12, wherein, for the determination of the maximum permissible quantity of energy, the ambient temperature, the temperature of the high-voltage energy store and/or the state-of-health of cells in the high-voltage energy store are considered.

15. An on-board power supply system for a motor vehicle, wherein the motor vehicle comprises a high-tension voltage network that includes a high-voltage energy store for the supply of voltage to one or more high-voltage loads, a main converter for converting the high-tension voltage which is present in the high-tension voltage network into a predefined low-tension voltage in a low-tension voltage network for the supply of voltage to one or more low-voltage loads, a battery management system, and a bypass converter assembly that, during a parking phase of the motor vehicle, introduces a predefined quantity of energy from the high-tension voltage network into the low-tension voltage network.

16. The on-board power supply system of claim 15, wherein the main converter is configured as a DC/DC converter having a maximum capacity of at least 1 kW.

17. The on-board power supply system of claim 15, wherein the bypass converter assembly is configured as a DC/DC converter having a maximum capacity not exceeding 100 W, in particular not exceeding 50 W.

18. The on-board power supply system of claim 15, wherein the bypass converter assembly is structurally integrated in the high-voltage energy store or in a common housing.

19. A motor vehicle having the on-board power supply system of claim 15.

20. The motor vehicle of claim 19, wherein the motor vehicle comprises an electric drive machine for electric driving operation, and wherein the high-voltage energy store is designed to supply energy to the electric drive machine.
